(19) United States
(12) Patent Application Publication
(10) Pub. No.: US 2008/0134551 A1
(43) Pub. Date: Jun. 12, 2008

(54) TABLETOP LAZY SUSAN

(75) Inventors: Harry Conforti, Andover, MA (US); Christopher Faris, Gloucester, MA (US); Chris Rowen, Rockport, MA (US); Eric McNiff, Gloucester, MA (US)

Correspondence Address: KNOBBE MARTENS OLSON & BEAR LLP, 2040 MAIN STREET, FOURTEENTH FLOOR, IRVINE, CA, 92614, US

(73) Assignee: Match Play Inc./dba Back 9 USA, Woburn, MA (US)

(21) Appl. No.: 11/836,097

(22) Filed: Aug. 8, 2007

Related U.S. Application Data
(60) Provisional application No. 60/836,191, filed on Aug. 8, 2006.

(51) Int. Cl. G09F 11/02

(52) U.S. Cl. 40/506; 108/27

(57) ABSTRACT

A tabletop lazy susan provides storage space for tabletop items, such as various types of condiment dispensers, utensils and napkins. Preferably, the lazy susan includes a central opening that is configured to receive the support shaft of a table umbrella. Accordingly, when the shaft of a table umbrella is passed through the opening of the lazy susan, the lazy susan cannot be easily removed from the tabletop. In preferred arrangements, the lazy susan includes spaces in which to receive menu and/or advertising media inserts. In one arrangement, the lazy susan includes one or more spaces configured to receive easily changeable menu inserts and includes one or more additional spaces configured to receive permanent, or at least less-easily removable, advertising inserts.

### RELATED APPLICATION

This application is related to, and claims priority from, U.S. Provisional Application No. 60/836,191, filed Aug. 8, 2006, the entirety of which is hereby incorporated by reference herein and made a part of the present specification.

### BACKGROUND OF THE INVENTION

1. Field of the Invention

The present invention relates generally to turntables, or lazy susans. More particularly, the present invention relates to a lazy susan that is well-suited for commercial use and, in one arrangement, provides advertising and/or menu capabilities.

2. Description of the Related Art

Lazy susans, also referred to as turntables, have been in use since at least the 1700s, and Thomas Jefferson is often credited with its invention. A lazy susan usually consists of a rotatable body having a surface upon which desired items may be placed. In colonial times, lazy susans would often be used for holding, and providing access to, various items, such as writing utensils and inkwells, for example. In addition, lazy susans were also used to provide convenient access to food and/or condiments through rotation of the lazy susan.

In commercial food service establishments, such as restaurants and bars, tabletop menus and advertisements are often provided on each table in some time of type of holder or carrier. Such advertisement or menu holders, however, may be inadvertently or purposely removed from the table by the staff or customers. As a result, advertisements or menus may not be available to later customers and, thus, are likely to be underutilized.

### SUMMARY OF THE INVENTION

In contrast, preferred embodiments of the present lazy susan provide storage space for tabletop items, such as various types of condiment dispensers. In addition, preferably, the lazy susan includes a central opening that is configured to receive the support shaft of a table umbrella. Accordingly, when the shaft of a table umbrella is passed through the opening of the lazy susan, the lazy susan cannot be easily removed from the tabletop. In addition, preferably, the lazy susan includes spaces in which to receive menu and/or advertising placards or other types of advertising media. In one arrangement, the lazy susan includes one or more spaces configured to receive easily changeable menu inserts and includes one or more additional spaces configured to receive permanent, or at least less easily removable, advertising inserts.

A preferred embodiment is a table top lazy susan that includes a base that supports the lazy susan on a surface. A carousel is rotatably supported by the base such that only the base contacts the surface and the carousel does not contact the surface. The carousel includes a bottom wall and a side wall that extends upward from the bottom wall. The bottom wall and the side wall cooperate to define a storage space of the carousel. The bottom wall defines a central opening configured to accommodate a shaft portion of a table umbrella, and the bottom wall completely surrounds the central opening.

Another preferred embodiment is a lazy susan as described above, and further including a first media location having a first space configured to receive a first media insert. The first space is enclosed such that the first media insert is not removable without disassembly of one or more components of the lazy susan. The lazy susan also includes a second media location having a second space configured to receive a second media insert. The second space is externally accessible such that the second media insert can be removed without disassembly of the lazy susan.

Yet another preferred embodiment is a table top lazy susan including a base and a carousel supported by the base. The carousel includes a bottom wall and a side wall that extends upward from the bottom wall. The bottom wall and the side wall cooperate to define a storage space of the carousel. The bottom wall defines a central opening configured to accommodate a shaft portion of a table umbrella, wherein the bottom wall completely surrounds the central opening. A rotational coupling is interposed between the carousel and the base and permits the carousel to be rotated relative to the base. At least one advertising media location is located on the side wall of the carousel and includes a space configured to receive an advertising insert. An entire periphery of the space is closed to inhibit undesired removal of the advertising insert.

Still another preferred embodiment is a table top lazy susan including a base that contacts a surface on which the lazy susan can be supported. A carousel is rotatably supported by the base such that only the base contacts the surface and the carousel does not contact the surface. The carousel includes a bottom wall and a side wall that extends upward from the bottom wall. The bottom wall and the side wall cooperate to define a storage space of the carousel. At least one non-removable media location is located on the side wall of the carousel and includes a first space configured to receive a first media insert. An entire periphery of the first space is closed to inhibit removal of the first media insert. At least one removable media location is located on the side wall of the carousel and includes a second space configured to receive a second media insert. A periphery of the second space defines an opening that permits the second media insert to be inserted into, and removed from, the second space.

### BRIEF DESCRIPTION OF THE DRAWINGS

These and other features, aspects and advantages of the present invention are described below with reference to drawings of preferred embodiments, which are intended to illustrate but not to limit the present invention. The drawings contain 11 figures.

FIG. 1 is a perspective view showing the top and side of a lazy susan having certain features, aspects and advantages of the present invention.

FIG. 2 is a perspective view showing a bottom and side of the lazy susan of FIG. 1.

FIG. 3 is a top view of the lazy susan of FIG. 1.

FIG. 4 is a bottom view of the lazy susan of FIG. 1.

FIG. 5 is a side view of the lazy susan of FIG. 1. Although only one side of the lazy susan is shown, the appearance of the remaining sides of the lazy susan is the same as the side shown in FIG. 5.

FIG. 6 is a cross-sectional view of the lazy susan of FIG. 1 taken along the line 6-6 of FIG. 4.

FIG. 7 is a perspective cross-sectional view of the lazy susan of FIG. 1, showing a menu insert location, or removable media location, on the right side of the lazy susan and an advertising insert location, or permanent media location, on a left side of the lazy susan.

FIG. 8 is a perspective view of a bottom of the lazy susan of FIG. 1 with a portion of the rim assembly removed to show bottom openings of vertical grooves that define a menu insert space and an advertising insert space of the lazy susan.

FIG. 9 is a top and side perspective view of a modification of the lazy susan of FIG. 1. The lazy susan of FIG. 9 includes a divider that separates an interior of the lazy susan into multiple compartments or sections. In addition, the side views, top and bottom views of the lazy susan of FIG. 9 are at least substantially the same as the side, top and bottom views of the lazy susan of FIGS. 1-8.

FIG. 10 is a top view of the lazy susan of FIG. 9.

FIG. 11 is a perspective view of yet another modification of the lazy susan of FIG. 9. The lazy susan of FIG. 11 includes removable carriers that are each configured to occupy at least a portion of a section of the lazy susan created by the divider.

### DETAILED DESCRIPTION OF THE PREFERRED EMBODIMENTS

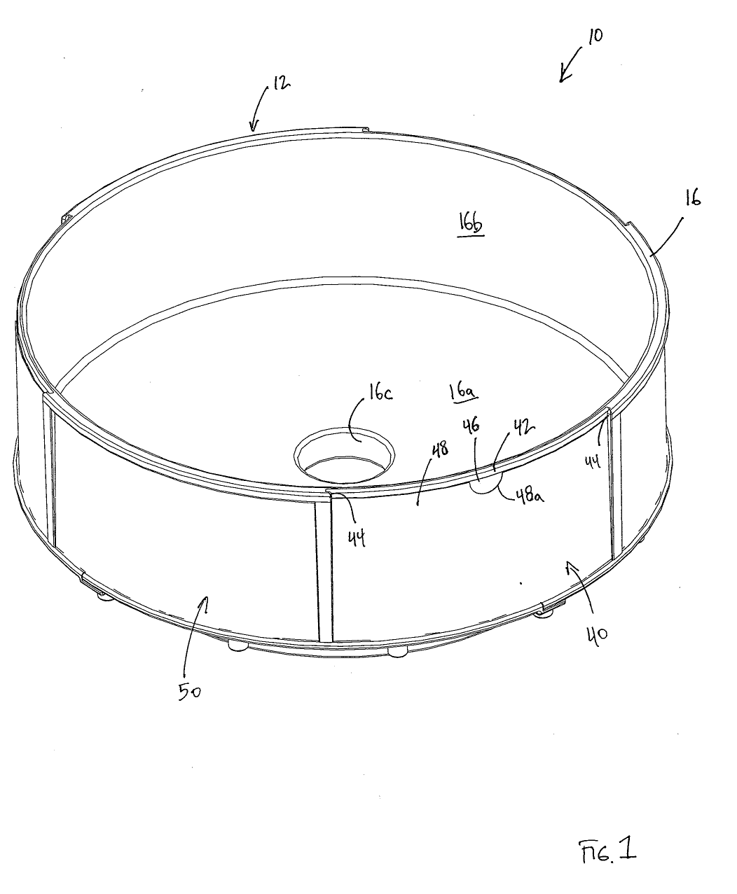

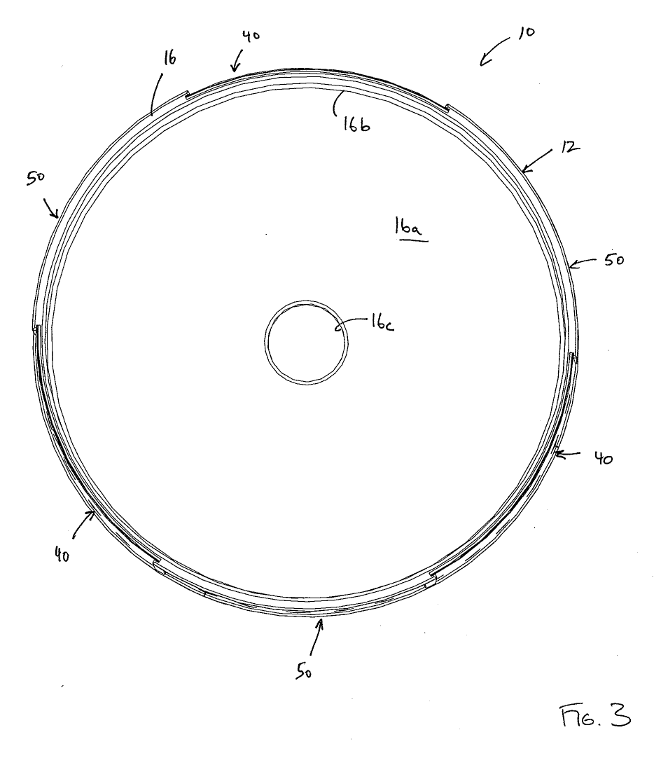

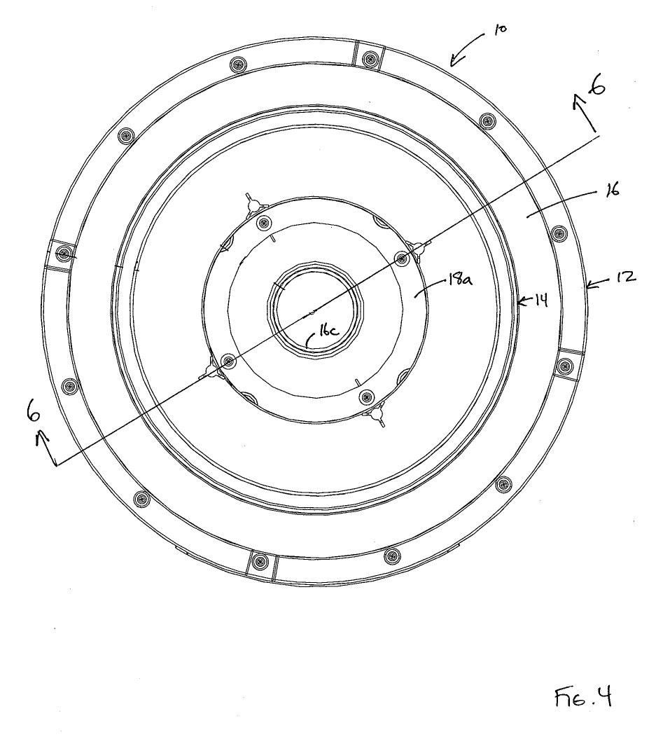

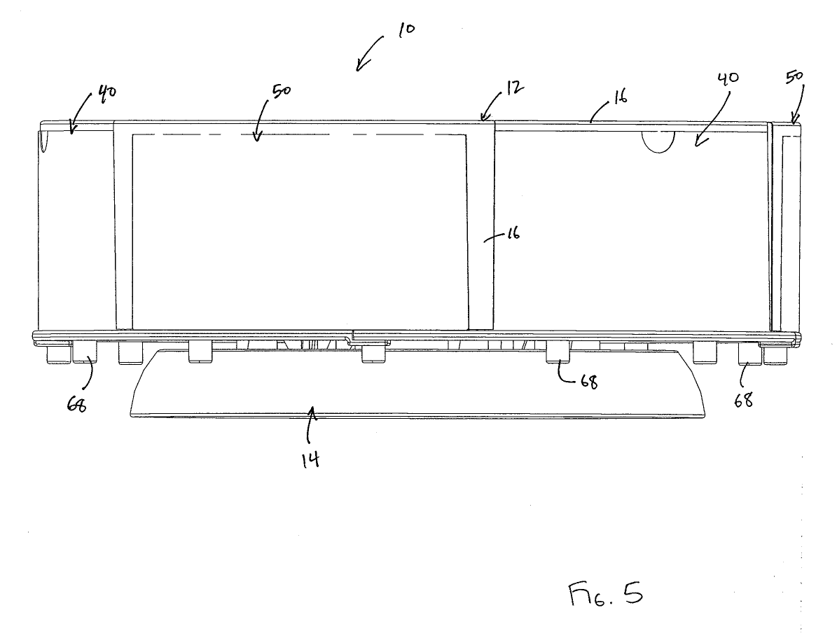

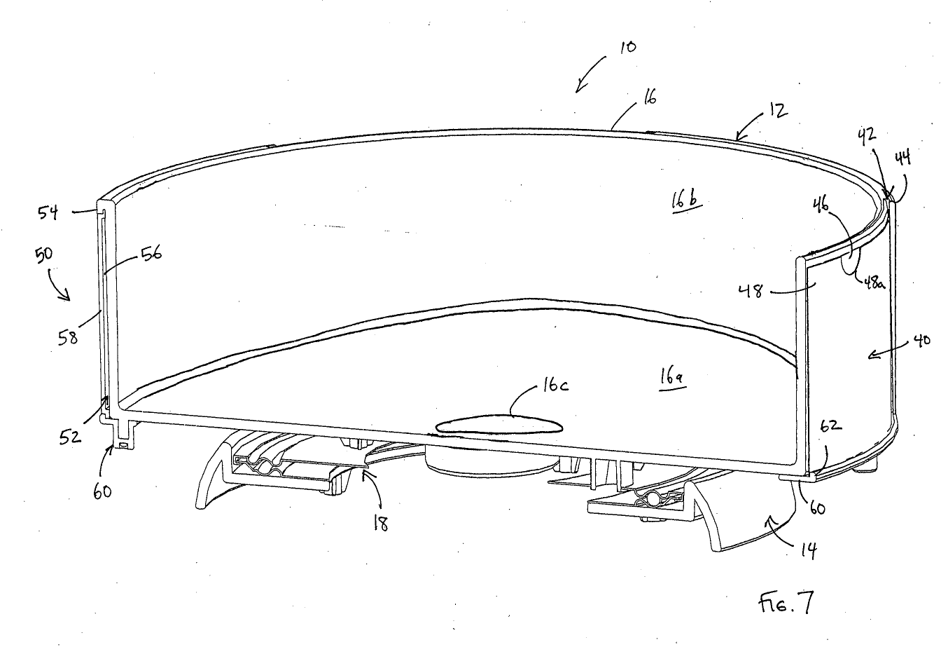

FIGS. 1-8 illustrate a first arrangement of a lazy susan 10 that is well-suited for tabletop use in a commercial food service establishment, such as restaurant or bar. The lazy susan 10 preferably has the capability to provide both easily replaceable inserts or placards, such as menu inserts, as well as more permanent inserts or placards, such as advertising inserts. In addition, in one arrangement, the lazy susan 10 is adapted to surround the shaft of a table umbrella such that undesirable removal of the lazy susan from the tabletop is inhibited (that is, removal of the lazy susan and, thus, the menus and advertisements, by customers is inhibited).

The illustrated version of the lazy susan 10 includes a tray or carousel 12 that is rotatably supported by a base 14. The illustrated base 14 has a substantially planar bottom surface that is configured to be placed on a relatively flat, level surface, such as a tabletop. The carousel 12 is rotatably supported relative to the base 14 and is generally located above the base 14. In the illustrated arrangement, the base 14 defines a diameter (or maximum dimension, if non-circular) that is smaller than the diameter (or maximum dimension) of the carousel 12 such that an outer peripheral portion of the carousel 12 overhangs the base 14.

The carousel 12 includes a carousel body 16. The illustrated carousel body 16 includes a substantially planar bottom wall 16a and an annular sidewall 16b that extends in an upward direction from a peripheral edge of the bottom wall 16a. Thus, the bottom wall 16a and sidewall 16b cooperate to define an interior space of the carousel 12. The interior space of the carousel 12 may be used as a storage space for tabletop items, such as condiment dispensers, utensils, napkins, and the like. In one arrangement, the diameter of the bottom wall 16a and, thus, a diameter of the carousel 12 is between about 12 inches and about 16 inches. In one arrangement, the height of the sidewall 16b is about 4 inches. However, the lazy susan 10 may include a carousel 12 that has other suitable sizes in both diameter and height dimensions as may be desired for a particular application. In addition, although a circular carousel 12 is illustrated, in other arrangements, the carousel may have a shape that is non-circular, such as oval or square, for example.

In one arrangement, the carousel body 16 includes an opening 16c in a central portion of the bottom wall 16a. The opening 16c is further defined by downwardly extending flange 16d, which extends in a downward direction from a lower surface of the carousel body. Preferably, the opening 16c is sized and shaped to receive the shaft of a table umbrella (not shown). In one arrangement, the opening 16c is roughly 2 inches in diameter. However, the particular size of the opening 16c may be altered to suit any particular application of the lazy susan 10. Preferably, the bottom wall 16a entirely surrounds the opening 16c such that removal of the carousel 12 in a direction perpendicular of the axis of the umbrella shaft is inhibited. As a result, the lazy susan 10 is inhibited from being undesirably removed from a table when an umbrella shaft is positioned through the opening 16c.

The base 14 is generally bowl-like in shape and includes a substantially planar upper wall 14a and a generally parabolic sidewall 14b that extends in a downward direction from the upper wall 14a. The bottom surface of the sidewall 14b preferably defines a generally planar support surface for the base 14 and, thus, for the lazy susan 10.

The upper wall 14a of the base 14 is generally parallel to the bottom wall 16a of the carousel body 16 and includes an aperture, or central opening 14c. The central opening 14c is aligned with the opening 16c of the carousel body 16 such that an umbrella shaft positioned within the opening 16c of the carousel body 16 also passes through the opening 14c of the base 14. However, in the illustrated arrangement, a diameter of the opening 14c is larger than a diameter of the opening 16c. Thus, in addition to accommodating the shaft of a table umbrella, the opening 14c also permits access to fasteners used in the assembly of the lazy susan 10, as is described in greater detail below. In addition, although the openings 14c and 16c are circular in the illustrated arrangement, other desirable shapes may be used as well.

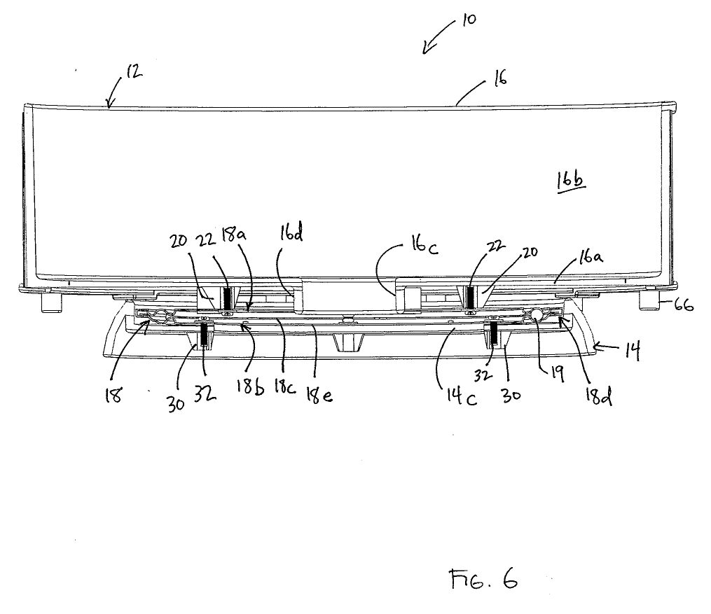

As described above, the carousel 12 is rotatably supported on the base 14. In the illustrated arrangement, a rotational coupling, or turntable assembly 18, is interposed between the carousel 12 and the base 14 (FIG. 6). The turntable assembly 18 includes an upper member, or upper plate 18a, and a lower member, or lower plate 18b. A plurality of bearing members, such as ball bearings 19, are interposed between the upper plate 18a and the lower plate 18b to facilitate relative rotation between the plates 18a, 18b. In addition, outer peripheral edges of the plates 18a, 18b are configured in an interlocking arrangement 18d, which prevents separation of the plates 18a, 18b in an axial direction.

The upper plate 18a is affixed to the carousel 12 and the lower plate 18b is affixed to the base 14. In the illustrated arrangement, the upper plate 18a is secured to the carousel body 16. In particular, at least one, and preferably a plurality of attachment bosses 20 extend in a downward direction from the bottom wall 16a of the carousel body 16. The bosses 20 include apertures which receive threaded fasteners 22 that secure the upper plate 18a to the carousel body 16. The apertures may have preformed threads or threads may be formed in the apertures as a result of insertion of the threaded fasteners 22.

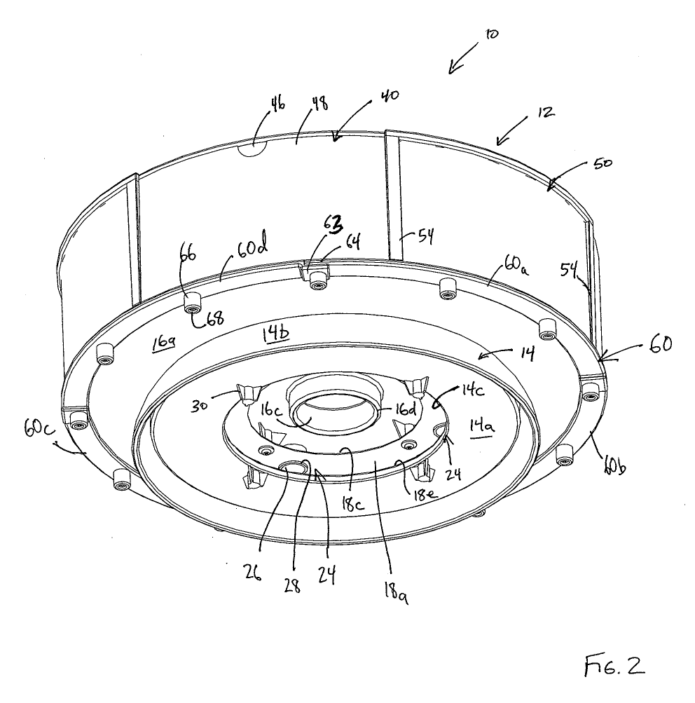

In the illustrated arrangement, the carousel 16 and the upper plate 18a are also interconnected with a torque transmitting arrangement 24 (FIG. 2). In the illustrated torque transmitting arrangement 24, at least one and preferably a plurality of drive members 26 extend in a downward direction from the bottom wall 16a of the carousel body 16. The drive members 26 are received by engagement portions 28 of the upper plate 18a. In the illustrated arrangement, the drive members 26 are hollow, cylindrical extensions that extend in a downward direction from the carousel body 16 and, preferably, are unitarily formed with the carousel body 16. The engagement portions 28 are circular apertures within the upper plate 18a that are configured to snugly receive the cylindrical extensions 26 to effectively transmit torque between the carousel body 16 and the upper plate 18a such that the shear force on the fasteners 22 and mounting bosses 20 is reduced. In the illustrated arrangement, four mounting bosses 20 and four torque transmission arrangements 24 are provided. However, in other arrangements other suitable numbers of fastening and/or torque transmission mechanisms may be provided.

The upper plate 18a includes a central opening 18c that is aligned with the openings 14c and 16c. Preferably a diameter of the opening 18c is greater than a diameter of the opening 16c of the carousel body 16 and is less than a diameter of the opening 14c of the base 14. Thus, the opening 18c also accommodates the shaft portion of a table umbrella. However, the threaded fasteners 22 are exposed within the opening 14c to be accessible therethrough.

As described above, the base 14 is coupled to the lower plate 18b of the turntable assembly 18. Preferably, the base 14 includes at least one and preferably a plurality of mounting bosses 30 that define (threaded or unthreaded) apertures which receive threaded fasteners 32. The mounting bosses 30 of the base 14 extend in a downward direction from the upper wall 14a of the base 14. The threaded fasteners 32 cooperate with the threaded apertures of the mounting bosses 30 to secure the lower plate 18b to the base 14. The fasteners 32 may be passed downwardly through the engagement openings 28 (or other access openings) and assembled to the mounting bosses of the base 14 prior to the carousel body 16 being assembled to the upper plate 18a. In the illustrated arrangement, four threaded fasteners 32 and mounting bosses 30 are provided to assemble the lower plate 18b to the base 14. However, in other arrangements, other suitable numbers of mounting bosses and/or fasteners 32 may be provided.

The lower plate 18b also includes an aperture, or central opening 18e, which is aligned with the openings 14c, 16c and 18c. The diameter of the central opening 18e preferably is sufficiently large to permit access to the threaded fasteners 22 from the lower side of the lazy susan 10 through the central opening 14c of the base 14. In the illustrated arrangement, the opening 18e is of generally the same diameter as the opening 14c of the base 14.

As illustrated in FIG. 6, the sidewall 14b of the base 14 extends above the upper wall 14a to create an interior space within the sidewall 14b configured to accommodate the turntable assembly 18. Thus, the base 14 and carousel body 16 cooperate to substantially hide the turntable assembly 18 from view to provide a pleasing external appearance to the lazy susan 10.

As described above, preferably the lazy susan 10 provides one or more locations in which easily changeable placards, inserts or other types of media can be positioned and one or more locations in which more permanent placards, inserts or other types of media can be positioned. In the illustrated arrangement, the lazy susan 10 includes three easily accessible insert locations, or menu insert locations 40, and three more permanent insert locations, or advertising insert locations 50. Both the menu insert locations 40 and the advertising insert locations 50 are configured to receive printed insert materials and permit the menu or advertising materials to be visible on the sidewall surface of the carousel 12. In other arrangements, the advertising locations may be configured to receive advertising media (e.g., printed directly on or formed directly by the carousel body 16). Preferably, each of the menu insert locations 40 and advertising insert locations 50 are approximately 4 inches high and 7 inches long. However, other sizes may be used as desired, or permitted or dictated by the size of the carousel 12.

The menu insert locations 40 include a groove or slot 42 that extends in a vertical direction within the sidewall 16b of the carousel body 16. The slot 42 is located generally centrally within a radial thickness of the sidewall 16b. The slot 42 is open at the upper end of the sidewall 16b and extends at least substantially all the way through the sidewall 16b in a vertical direction. An outward facing portion of the sidewall 16b is removed such that the slot 42 is exposed to the external side of the carousel 12. Retaining portions or flanges 44 are positioned on a forward side of the slot 42 and extend inward a relatively small distance from each side of the slot 42. In the illustrated arrangement, the retaining flanges 44 retain an insert 46 and relatively thin, protective cover or cover plate 48 within the slot 42. The cover 46 is preferably transparent, or at least translucent, such that the insert 46 positioned within the slot 42 between the sidewall 16b of the carousel and the cover 48 may be viewed through the cover 48. In the illustrated arrangement, the cover 48 includes an upper, centrally-located cut-out 48a that permits the insert 48 to be removed from the slot 42.

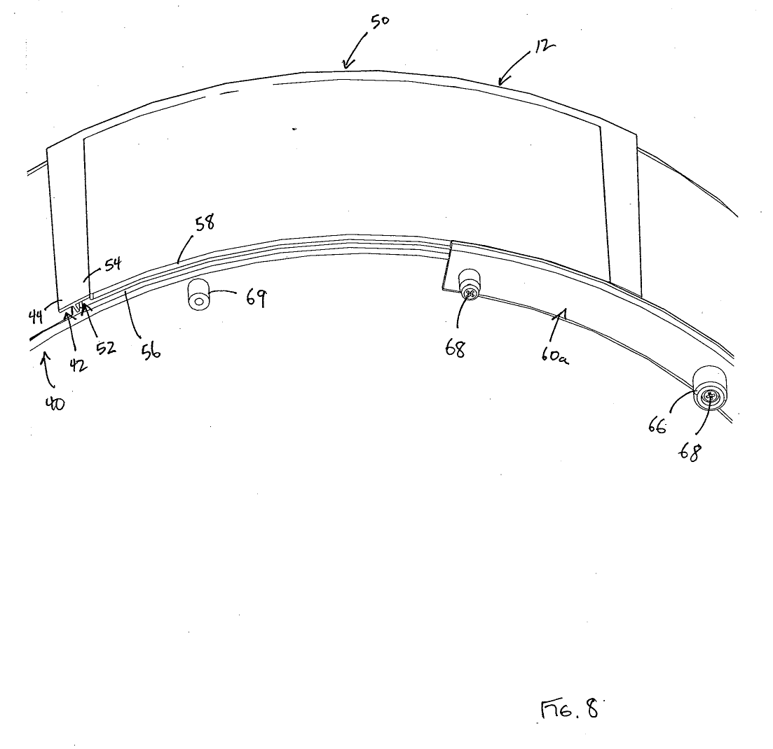

The advertising insert locations 50 are generally similar to the menu insert locations 40. The advertising insert locations 50 include a groove or slot 52 that extends in a vertical direction through the sidewall 6b of the carousel body 16. The slot 52 originates from a lower end of the sidewall 16b and extends toward the upper end of the sidewall 16b, preferably without passing through the upper end of the sidewall 16b. Thus, the slot 52 terminates prior to the upper end of the sidewall 16b. A majority of the portion of the sidewall 16b toward the outside of the slot 52 is removed such that the slot 52 is exposed to the external side of the carousel 12. Retaining portions or flanges 54 are positioned on a forward side of the slot 52 and extend inward a relatively small distance from each side and the top of an outward portion of the slot 52 so as to retain an advertising insert 56 and a cover 58 within the slot 52. The advertising insert 56 preferably is a relatively thin sheet of printed material that includes advertising media on its outer surface. Preferably, the cover sheet 58 is a transparent, or at least translucent, relatively thin member that covers and protects the advertising insert 56, while permitting the advertising insert 56 to be visible through the cover 58. Peripheral top and side edges of the cover 58 are retained within the slot 52 by the retaining flanges 54. The peripheral edges of the cover 58 may be offset (rearwardly, in the illustrated arrangement) from the central portion of the cover 58, as shown in FIG. 8.

With additional reference to FIG. 2, lower ends of the grooves 42, 52 are closed by a rim assembly 60. The rim assembly 60 is annular in shape and is sized and shaped to extend about an outer periphery of the bottom wall 16a of the carousel body 16. The rim assembly 60 includes a lip 62 that extends a short distance up the sidewall 16b of the carousel body 16. Thus, the rim assembly 60 closes a lower end of the groove 42 of the menu insert portion 40 and acts as a retainer to retain the inserts 46, 56 and covers 48, 58 within the slots 42, 52. Thus, the menu inserts 46 may be removed from the upper end of the slot 42 but are prevented from exiting the slot 42 from a lower end by the rim assembly 60. Accordingly, the menu inserts 46 may be removed from the slot 42 without disassembly of the lazy susan 10 The rim assembly 60 also closes a lower end of the groove 52 that accommodates the advertising insert 56, the upper end of which is closed by the upper end of the sidewall 16b, as described above. Thus, the advertising insert 56 is only removable from the groove 52 by removal of the rim assembly 60 from the carousel 12.

In the illustrated arrangement, the rim assembly 60 includes multiple rim members 60a, 60b, 60c and 60d. Each rim member 60a-60d is arcuate in shape and cooperates with the others to define the annular rim assembly 60. One end 63 of each rim member 60a-60d is vertically offset from the remainder of the rim member 60a-60d by a distance equal to the thickness of the rim member 60a-60d such that the end 63 overlaps an opposite end portion 64 of an adjacent rim member 60a-60d, as shown.

Each rim member 60a-60d defines a plurality of mounting bosses 66 that receive a threaded fastener 68 that secures the rim assembly 60 to the carousel body 16. In the illustrated arrangement, each rim member 60a-60d includes three mounting bosses 66. Each fastener 68 engages a mounting boss 69 (FIG. 8) that extends downward from the carousel body 16 and is sized to fit within a hollow interior of the mounting bosses 66 of the rim members 60a-60d. The mounting bosses 69 of the carousel body 16 may be pre-threaded, or may have threads formed by the insertion of the threaded fasteners 69.

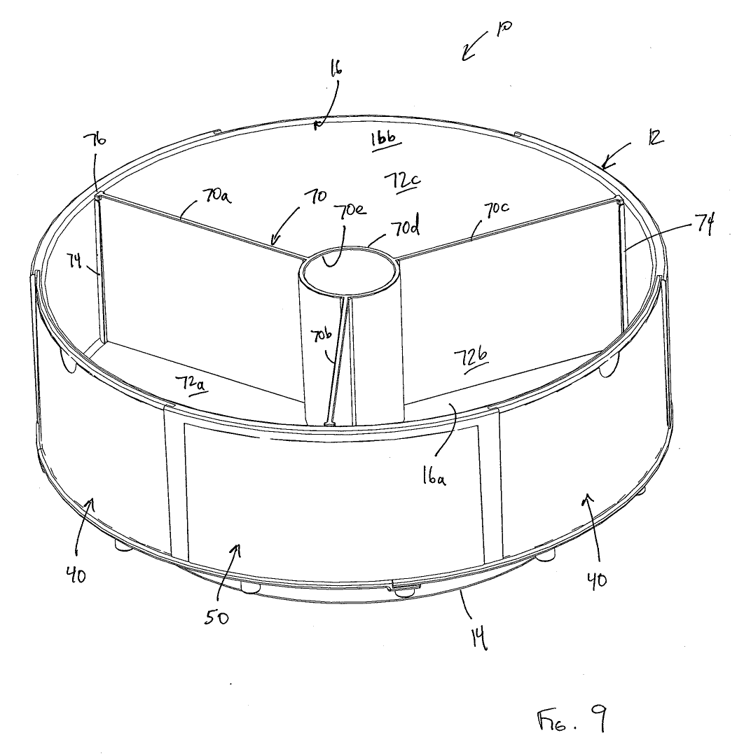

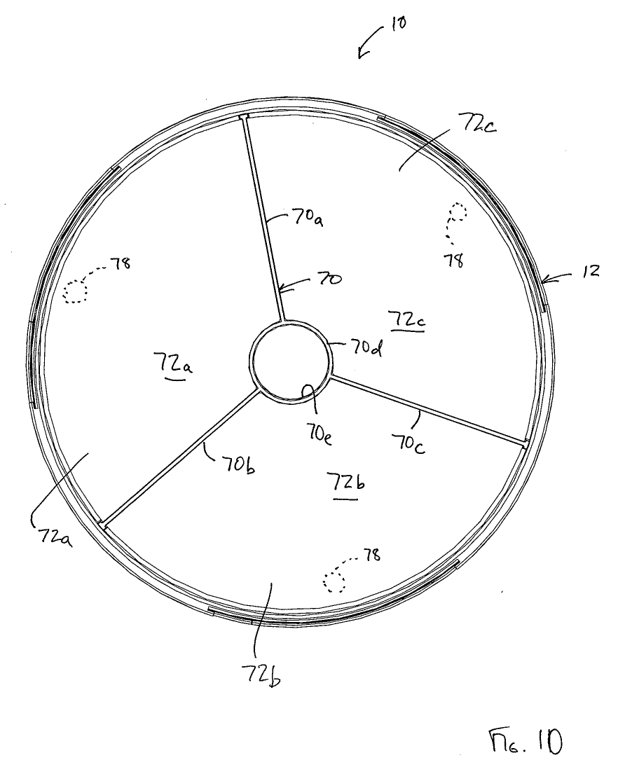

FIGS. 9 and 10 illustrate a modification of the lazy susan 10 of FIGS. 1-8. Preferably, in all respects except for those described below, the lazy susan 10 of FIGS. 9 and 10 is substantially similar to the lazy susan 10 of FIGS. 1-8, and thus the details of the lazy susan 10 are not repeated below. In addition, the same reference numerals are used to identify the same, or similar, components throughout the figures. The carousel 12 of the lazy susan 10 of FIGS. 9 and 10 is configured to receive a divider 70 that segments the interior space defined by the carousel 12 into a plurality of sections. In the illustrated arrangement, the divider 70 includes three walls 70a, 70b and 70c that divide the interior of the carousel 12 into three segments or spaces 72a, 72b and 72c. The walls 70a, 70b, 70c are interconnected by a hollow cylindrical portion 70d. The cylindrical portion 70d defines an opening 70e that aligned with the opening 16c of the carousel 12. Thus, the opening 70e is sized and shaped to accommodate the shaft of a table umbrella. Preferably, a diameter of the opening 70e is substantially equal to the diameter of the opening 16c of the carousel 12. In the illustrated arrangement, the height of the walls 70a, 70b, 70c and the cylindrical portions 70d is substantially equal to the height of the sidewall 16b of the carousel 12.

The illustrated lazy susan 10 includes a mechanism for fixing a rotational position of the divider 70 relative to the carousel 12. In particular, an inner surface of the sidewall 16b of the carousel 12 includes at least one pair of vertical flanges 74 that cooperate with one another to define a groove that preferably snugly receives an end portion of a wall 70a, 70b, 70c. Desirably, one pair of flanges 74 is associated with each of the walls 70a, 70b, 70c. An upper end of the flanges 74 terminates prior to an upper surface of the sidewall 16b to accommodate a tab 76 formed on an upper, outer corner of each wall 70a, 70b, 70c.

With reference to FIG. 10, the carousel 12 of the lazy susan 10 of FIGS. 9 and 10 may also include one or more drainage holes 78 that extend through the bottom wall 16a of the carousel body 16 to permit any moisture within the interior space of the carousel 12 to be evacuated from the interior space of the carousel 12. Although circular drain holes 78 are shown, drain holes may be provided in any desirable shape. In addition, although the illustrated drain holes 78 are located within the bottom wall 16a, in other arrangements, the drainage hole 78 may be located partially or wholly on the sidewall 16b, or in other suitable locations of the carousel 12.

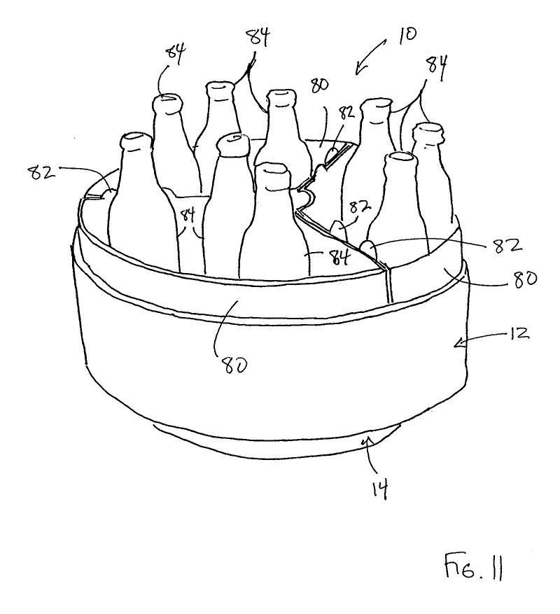

FIG. 11 illustrates a lazy susan 10 similar to the lazy susan 10 of FIGS. 1-8 or the lazy susan 10 of FIGS. 9 and 10. However, in FIG. 11 the lazy susan 10 includes multiple carrier inserts 80, each one of which may be positioned in one of the segments 72a, 72b, 72c of the interior space of the carousel 12. In the illustrated arrangement, a carrier insert 80 is positioned within each of the segments 72a, 72b, 72c. Preferably, the carrier insert 80 is positioned to occupy substantially the entirety of its respective segment 72a, 72b, 72c. In addition, the carrier insert 80 has a height that is greater than the height of the sidewall 16b of the carousel body 16 such that an upper end of the carrier inserts 80 extends above an upper end of the carousel 12. In addition, the carousel insert may include gripping tabs 82 that ease the insertion and removal of the carrier inserts 80 into the carousel 12. The carrier inserts 80 are thin-walled structures that define an interior space that is able to hold desirable items, such as beverage bottles 84, for example. Thus, the items, such as beverage bottles 84, may be brought to the table separately from the lazy susan 10 and placed into the lazy susan 10 to provide a convenient storage location. In other arrangements, the carrier inserts 80 may have an upper wall that defines one or more cavities configured to receive objects to be carried. The cavities may be specifically sized and shape to accommodate a desired object, such as a particular beverage can or bottle, for example. In addition, the carrier inserts 80 may provide branding or other advertising opportunities.

Although this invention has been disclosed in the context of certain preferred embodiments and examples, it will be understood by those skilled in the art that the present invention extend beyond the specifically disclosed embodiments to other alternative embodiments and/or uses of the invention and obvious modifications and equivalence thereof. In particular, while the present lazy susan 10 has been described in the context of particularly preferred embodiments, the skilled artisan will appreciate, in view of the present disclosure, that certain advantages, features and aspects of the lazy susan may be realized in a variety of other applications, many of which have been noted above. Additionally, it is contemplated that various aspects and features of the invention described can be practiced separately, combined together, or substituted for one another, and that a variety of combination and subcombinations of the features and aspects can be made and still fall within the scope of the invention. Thus, it is intended that the scope of the present invention herein disclosed should not be limited by the particular disclosed embodiments described above, but should be determined only by a fair reading of the claims.

What is claimed is:

1. A table top lazy susan, comprising:
a base;
a carousel supported by said base, said carousel comprising a bottom wall and a side wall that extends upward from said bottom wall, said bottom wall and said side wall cooperating to define a storage space of said carousel, said bottom wall defining a central opening configured to accommodate a shaft portion of a table umbrella, wherein said bottom wall completely surrounds said central opening;
a rotational coupling interposed between said carousel and said base, said rotational coupling permitting said carousel to be rotated relative to said base; and
at least one advertising media location located on said side wall of said carousel, said at least one advertising media location comprising a space configured to receive an advertising insert, wherein an entire periphery of said space is closed to inhibit undesired removal of said advertising insert.

2. The lazy susan of claim 1, wherein said space is defined by a cover plate that cooperates with said side wall of said carousel, and wherein said advertising insert is received between said cover plate and said carousel, and said advertising insert is visible through said cover plate.

3. The lazy susan of claim 2, further comprising a retainer that is coupled to said carousel by at least one fastener, wherein said retainer secures said cover plate to said carousel and wherein removal of said at least one fastener allows said retainer to be removed from said carousel, which allows said cover plate to be separated from said carousel to permit removal of said advertising insert from said space.

4. The lazy susan of claim 3, further comprising at least one menu media location located on said side wall of said carousel, said at least one menu media location comprising a menu insert space configured to receive a menu insert, wherein a portion of a periphery of said menu insert space is open to permit said menu insert to be inserted into, or removed from, said menu insert space.

5. The lazy susan of claim 4, wherein said retainer closes a lower end of said menu insert space.

6. The lazy susan of claim 2, wherein said retainer is a generally annular rim that is sized and shaped to cover an outer peripheral edge of said bottom wall of said carousel.

7. The lazy susan of claim 6, wherein said rim comprises a lip that extends upward along a portion of said side wall of said carousel to contact a portion of a periphery of said cover plate.

8. The lazy susan of claim 2, wherein said carousel defines a slot that receives at least a portion of a periphery of said cover plate.

9. A table top lazy susan, comprising:
a base that contacts a surface on which said lazy susan can be supported;
a carousel rotatably supported by said base such that only said base contacts said surface and said carousel does not contact said surface, said carousel comprising a bottom wall and a side wall that extends upward from said bottom wall, said bottom wall and said side wall cooperating to define a storage space of said carousel;
at least one non-removable media location located on said side wall of said carousel, said at least one non-removable media location comprising a first space configured to receive a first media insert, wherein an entire periphery of said first space is closed to inhibit removal of said first media insert; and
at least one removable media location located on said side wall of said carousel, said at least one removable media location comprising a second space configured to receive a second media insert, wherein a periphery of said second space defines an opening that permits said second media insert to be inserted into, and removed from, said second space.

10. The lazy susan of claim 9, wherein said first space is defined by a cover plate that cooperates with said side wall of said carousel, and wherein said first media insert is received between said cover plate and said carousel, and said first media insert is visible through said cover plate.

11. The lazy susan of claim 10, wherein said carousel defines a slot that receives at least a portion of a periphery of said cover plate.

12. The lazy susan of claim 10, further comprising a retainer that is coupled to said carousel by at least one fastener, wherein said retainer secures said cover plate to said carousel and wherein removal of said at least one fastener allows said retainer to be removed from said carousel, which allows said cover plate to be separated from said carousel to permit removal of said first media insert from said first space.

13. The lazy susan of claim 12, wherein said retainer closes a lower end of said second space.

14. The lazy susan of claim 12, wherein said retainer is a generally annular rim that is sized and shaped to cover an outer peripheral edge of said bottom wall of said carousel.

15. The lazy susan of claim 14, wherein said rim comprises a lip that extends upward along a portion of said side wall of said carousel to contact a portion of a periphery of said cover plate.

16. A table top lazy susan, comprising:
a base that supports said lazy susan on a surface;
a carousel rotatably supported by said base such that only said base contacts said surface and said carousel does not contact said surface, said carousel comprising a bottom wall and a side wall that extends upward from said bottom wall, said bottom wall and said side wall cooperating to define a storage space of said carousel, said bottom wall defining a central opening configured to accommodate a shaft portion of a table umbrella, wherein said bottom wall completely surrounds said central opening.

17. The lazy susan of claim 16, further comprising:
a first media location comprising a first space configured to receive a first media insert, said first space being enclosed such that said first media insert is not removable without disassembly of one or more components of said lazy susan;
a second media location comprising a second space configured to receive a second media insert, said second space being externally accessible such that said second media insert can be removed without disassembly of said lazy susan.

18. The lazy susan of claim 16, further comprising a rotational coupling interposed between said carousel and said base, said rotational coupling facilitating rotation of said carousel relative to said base.

19. The lazy susan of claim 18, wherein said rotational coupling comprising an upper member that is rotatable relative to a lower member, wherein said carousel further comprises at least one drive member that engages said upper member to transmit torque between said carousel and said upper member of said rotational coupling.

20. The lazy susan of claim 19, further comprising at least one fastener that fastens said carousel to said upper member of said rotational coupling.
